(19) United States
(12) Patent Application Publication
(10) Pub. No.: US 2018/0374167 A1
(43) Pub. Date: Dec. 27, 2018

(54) SIMULATION OF A PHYSICAL FLOW TRANSPORT NETWORK

(71) Applicant: SUEZ GROUPE, Paris La Defense Cedex (FR)

(72) Inventors: Vincent LENOUVEL, PARIS (FR); Camille POIROUX, Escalier A (FR); Laure FREMEAUX, PARIS (FR); Martin WAIN, PARIS (FR); Samy LABEYRIE, SAINT-DENIS (FR)

(21) Appl. No.: 16/063,624

(22) PCT Filed: Dec. 16, 2016
(86) PCT No.: PCT/EP2016/081377

§ 371 Date: Jun. 18, 2018

(30) Foreign Application Priority Data
Dec. 17, 2015 (FR) 1562632

(51) Int. Cl. G06Q 50/06; G06F 17/50; G06Q 10/06; G06F 17/30

(52) U.S. Cl. CPC G06Q 50/06; G06F 17/5009; G06F 17/30958; G06Q 10/063; G06F 17/509

(57) ABSTRACT

Disclosed is a method for modelling a physical flow management system for a territory, by forming an oriented graph including nodes and oriented edges, wherein each device is represented by a node of the oriented graph, and each point of use is represented by a node of the oriented graph.

### FIELD OF THE INVENTION

The invention falls within a context of improving the performance of urban services that are water, energy or waste management services.

### PRIOR ART

To that end, checking matching of a scenario including technical solutions with an estimation of needs and capabilities of a territory is generally provided.

Usually, this step is made by means of simulations of the scenario. Generally, each flow of an urban service is modelled independently of other flows of other urban services.

One purpose of the invention is to provide a method for modelling a physical flow management system for a territory which enables a homogeneous and consistent representation of technical devices of urban services of said territory to be obtained.

### DISCLOSURE OF THE INVENTION

One purpose of the invention is achieved with a method for modelling a physical flow management system for a territory, the steps of which are implemented by a computer program product, the system comprising technical devices and points of use, of an urban service, each technical device receiving on an input a physical flow called an input flow and applying a transformation to the input flow to deliver on an output a physical flow called an output flow, each point of use receiving a physical flow called a need flow on an input and delivering a physical flow called a refuse flow on an output, the technical devices and points of uses being connected to each other by means of junctions.

According to the invention, the method comprises, from a predetermined list of physical flows forming a flow vector, the following steps:
a first step of forming an oriented graph comprising nodes and oriented edges,
   each technical device being represented by a node of the oriented graph, each of said nodes being associated with:
      a first flow vector, called an input flow vector, representative of the input flow of said node,
      a second flow vector, called an output flow vector, representative of the output flow of said node,
      a mathematical function, also called a transformation function, representing a relationship between the output flow vector and the input flow vector,
   each point of use being represented by a node of the oriented graph, each of said nodes being associated with:
      a first flow vector, called a need flow vector representing the physical flow quantities necessary to said territory,
      a second flow vector, called a refuse flow vector representing the physical flow quantities generated by said territory,
   each junction between the output of a technical device and the input of another technical device being represented by an oriented edge of the oriented graph, the oriented edge connecting on the one hand the node associated with the technical device or with the point of use; and on the other hand the node associated with the other technical device or with the point of use,
iteratively, for each oriented edge connected to a node either the input flow vector, or the output flow vector of which is determined beforehand, a second step of determining the other vector by using the transformation function.

Preferably, the steps of the method according to the invention are only implemented by technical means.

Preferably, the need flow vector and the refuse flow vector are equal and form a vector called a diagnostic vector. The diagnostic vector can be the result of a step implemented prior to the method according to the invention, usually called a diagnostic step.

When the transformation function, also called a matrix, connects the output flow vector as a function of the input flow vector, the node associated with the device is called a downstream node. In the opposite case, the node associated with the technical device is called an upstream node.

A physical treatment device can have one or more inputs and outputs.

A physical flow is a flow passing through the system, for example, a water flow, an energy flow, or a waste flow.

The water, energy and waste flows can respectively be expressed in cubic metres, in kilowatt-hours and in tons.

The technical devices can have production, storage, supply, transport, collection or treatment functions.

A technical device can, for example, be:
a photovoltaic solar panel receiving a solar energy physical flow received on an input and delivering an electric energy physical flow on an output,
a rainwater harvesting vessel receiving a water physical flow received on an input and delivering a physical water flow on an output,
a biogas plant (methaniser) receiving a waste physical flow and an electric energy physical flow received on two inputs and delivering a waste physical flow and an energy physical flow on two outputs,
a drinking water supply system receiving a drinking water physical flow on an input and delivering a drinking water physical flow on an output.

Even if a technical device does not receive a physical flow of some type, the input and output flow vectors of the node associated with the technical device have all the components of the list of flows.

By associating a same predetermined list of physical flows with each of the nodes associated with a technical device, the method according to the invention has the advantage to enable an homogenously and consistently representation of technical devices that can belong to different urban services.

The method according to the invention allows the physical flows generated by each of the technical devices to be known.

The method according to the invention enables a balance of physical flows to be made at the territory.

According to one feature, the technical device is associated with intrinsic characteristics and/or with extrinsic characteristics to the device in the system.

A compliance of extrinsic or intrinsic capabilities of each physical device with the input flow and output flow vectors associated with the node representing said technical device can be checked.

The treatment capabilities of an incinerating unit, the diameter of a piping and the energy efficiency of a production unit are examples of intrinsic capabilities of a technical device. The flow rate of a water course, pluviometry and sunshine are examples of extrinsic technical characteristics of a technical device.

Advantageously, checking matching of the physical flow management system of the territory to the urban service can be provided. This checking step enables robustness of the method according to the invention to be ensured.

The method according to the invention can include, for each technical device:
a fourth step of determining a test value from components of the input flow vector and/or of the output flow vector,
a fifth step of comparing the test value to a range of permissible values for said technical device.

The method according to the invention can comprise a sixth step of aggregating nodes to form a sub-set representing a sub-territory comprising a flow vector called an input flow vector and a flow vector called an output flow vector, wherein:
the input flow vector is determined by adding the output vectors of the outer nodes to the sub-set and connected by an edge toward an inner node to the sub-set,
the output flow vector is determined by adding the input vectors of the outer nodes to the sub-set and connected by an edge from an inner node to the sub-set.

This characteristic has the advantage to enable balances of physical flows to be made for sub-territories and thus the different balances to be analysed according to several criteria. The flows passing through the technical devices inside or outside a sub-territory can thus be distinguished.

Preferably, the list of physical flows comprises two different categories of flow. A water flow, an energy flow and a waste flow make up different flow categories.

Preferably, the list of physical flows comprises two different elementary flows. An elementary flow is defined by properties considered as identical for an urban service.

An elementary flow can be a flow associated with a need or a use:
greywater, blackwater, rainwater, drinking water and raw water are different elementary flows of water flows,
gas, electricity, fuel and heat are different elementary flows of energy flow,
glass and paper are different elementary flows of waste flow.

Preferably, for each technical device, the method according to the invention comprises a step of determining environmental, economic and social impacts from components of the input flow vector and/or the output flow vector.

The method according to the invention enables an assessment of the environmental, economic and social impacts to be made based on the balance of physical flow.

Advantageously, costs, employments or greenhouse effect gas emissions associated with the technical devices and physical flows can be in particular calculated.

Advantageously, each node is associated with a player of the facility, being competent to make use of the device associated with the node.

The association of each node with a player responsible for the device associated with the node enables physical flows to be followed up according to the governances of the urban service(s).

Advantageously, each node is associated with a geographical position.

The association of each node with a geographical position enables physical flows to be followed up according to the geographical characteristics of the territory.

The joint implementation of associations of geographical positions with nodes and the aggregating step has a remarkable interest in investigating flows of a geographical territory.

The joint implementation of the association of facility player with nodes and the aggregating step has a remarkable interest in investigating flows per player.

According to another aspect of the invention, a computer program product directly loadable in the internal memory of a computer, comprising software code portions for running the steps of the method according to one of the preceding claims is provided, when said program is run on a computer.

### DESCRIPTION OF THE FIGURES

Further features and advantages of the invention will appear upon reading the detailed description of implementations and embodiments in no way limiting, with regard to the appended figures in which:

FIG. 1 illustrates four technical devices implemented in an urban service;

FIG. 2 illustrates a modelling of technical devices of FIG. 1;

FIG. 3 illustrates a method according to the invention;

FIG. 4 illustrates an embodiment of the method of FIG. 3.

### DESCRIPTION OF THE INVENTION

Since these embodiments are in no way limiting, alternative embodiments of the invention could in particular be made, only comprising a selection of characteristics described in the following, as described or generalised, isolated from the other characteristics described, if this selection of characteristics is sufficient to provide a technical advantage or to differentiate the invention with respect to the state of the art.

A territory comprises several urban services, such as that of waste, rainwater, waste water collection, electricity or drinking water supply, heat or electricity generation.

All these urban services are modelled by a method 100 according to the invention for modelling said services for a physical flow management system 200 for the territory.

The system 200 comprises technical devices as well as a point of use.

In the example represented in FIG. 1, the system comprises two treatment devices 202, 210, respectively in the form of a water purification station and a rainwater reuse system. The system further comprises two transport devices 204, 206, respectively a transport network 204 and a supply network 206. The system further comprises a point of use 208.

The water purification station 202 directly feeds the transport network 204. To that end, there is a junction 2024 between the water potabilization station 202 and the transport network 204.

The supply network 204 feeds the supply network 206 by means of a junction 2046.

The point of use 208 has a need flow, fed by the supply network 206 by means of a junction 2068 as well as by the rainwater reuse system 210 by means of a junction 2108.

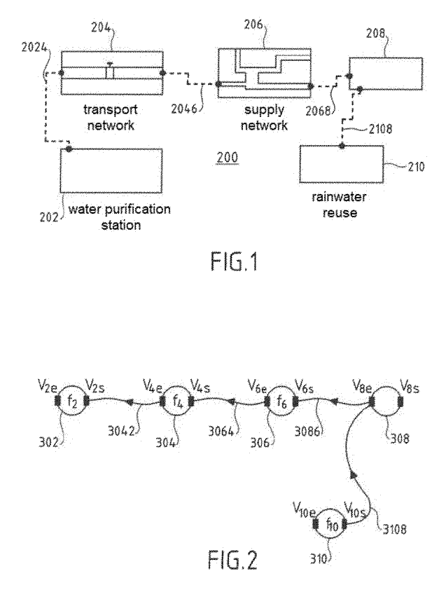

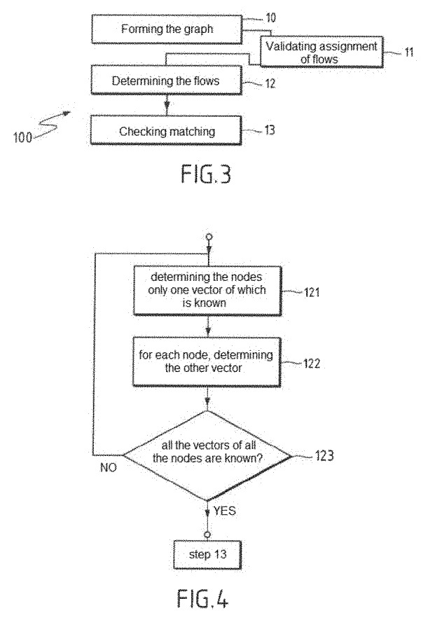

As illustrated in FIG. 3, the method 100 according to the invention comprises:
forming 10 an oriented graph illustrated in FIG. 2;
validating 11 the assignment of flows;
determining 12 flow vectors of the graph;
checking 13 matching of test values to ranges of values.

During step 10, each of the devices 202, 204, 206 and 210 is represented by a node, 302, 304, 306 and 310 respectively. The nodes 302, 304, 306 and 308 are provided with inlet and outlet flow vectors v2e and v2s, v4e and v4s, v6e and v6s as well as v10e and v10s and are characterised by parameters representative of their operation such as pluviometry, network efficiency, location thereof.

The point of use 208 is represented by a node 208. The point of use 208 is provided with a first flow vector v8e, called a need flow vector, representing the physical flow quantities necessary to the territory as well as a second flow vector v8s, called a refuse flow vector, representing the physical flow quantities generated by said territory.

Oriented edges, 3042, 3064, 3086, and 3108 respectively are disposed from the node 304 to the node 302, from the node 306 to the node 304, from the node 308 to the node 306 and from the node 310 to the node 308 respectively.

The validation of assignment of the flows 11 makes it possible to validate that the oriented edges direct the flows to nodes suitable for receiving them. It is for example checked that a waste flow is not directed to a water supply technique. It is also checked that each node has flows necessary to its operation.

Determining 12 the flow vectors of the graph starts with determining the flow vectors v8e and v8s. The flow vectors v8e and v8s are initialised with values representing the quantities, which are measured or predicted, of need flows and refuse flows of the point of use.

Transformation mathematic functions f2, f4, f6 and f10, representing a relationship between the output flow vector and the input flow vector are respectively associated with the nodes 302, 304, 306 and 310. More precisely, the relationships are v2e=f2(v2s), v4e=f4(v4s), v6e=f6(v6s), for upstream nodes and v10s=f10(v10s) for a downstream node.

Determining 12 is continued with a step 121 of all the nodes having a single known vector. In the example illustrated in FIG. 2, the input vector of the rainwater reuse system v10e (depending on pluviometry) as well as the need flow vector v8e are known.

Determining 12 is continued with a step 122 of determining the other vector, for each of the nodes determined in step 121. In the example illustrated in FIG. 2, v10s=f10(v10e) is then determined and the flow f3108 carried by the edge 3108 is further deduced therefrom. Since the vector v8e is known, v6s=v8e−v10s is deduced therefrom.

Determining 12 is continued with a test step 123, checking whether all the vectors of all the nodes of the graph are known.

When the result of the test step 123 is yes, the test step enables the step of determining the flows 12 to be ended and the method is continued with step 13.

When the result of the test step 123 is no, the method is continued with a new step 121.

In the example illustrated in FIG. 2, the output vector v6s of the supply node 306 is then known. Step 123 is then continued with a new step 121, during the new step 121, the node 306 is identified.

During a new step 122, the flow vector v6e is determined, by applying the relationship v6e=f6(v6s). The flow f3064 carried by the edge 3064 which is equal to v4s is further deduced therefrom.

In the example illustrated in FIG. 2, the output vector v4s of the transport node 304 is then known. Step 123 is then continued with a new step 121 during which the node 304 is identified.

During a new step 122, the flow vector v4e is determined, by applying the relationship v4e=f4(v4s). The flow f3042 carried by the edge 3042 which is equal to v2s is further deduced therefrom.

In the example illustrated in FIG. 2, the output vector v2s of the water purification node 302 is then known. Step 123 is thus continued with a new step 121 during which the node 302 is identified.

During a new step 122, the flow vector v2e is determined, by applying the relationship v2e=f2(v2s).

Step 122 is continued with the test 123 which performs the method in step 13.

Checking 13 matching of test values to ranges of values comprises determining a test value from components of the input flow vector and/or the output flow vector, and comparing the test value to a range of permissible values for the technical device.

According to one embodiment of the invention, a computer program product directly loadable into the internal memory of a computer is provided, comprising software code portions for running the steps of the method according to one of the preceding claims, when the program is run on a computer.

An implementation of the method according to the invention for modelling a district of 200 ha is now described.

This modelling includes implementing in a simulation tool, such as a computer program product implementing the method according to the invention, a scenario representing a system including placing a biogas plant (as a technical device) arranged to be fed by green waste, biowaste and edible oils from the district. The system is arranged such that the energy produced by the biogas plant feeds the heating network of the district (as a point of use).

A sustainable energy rate objective in the network higher than 60% is assigned to the simulation tool.

Data from a diagnostic module of the simulation tool, in particular the quantity of biowaste produced and heat needs for the buildings are imported into the simulation tool and a simulation is initiated.

According to this implementation, an error message can be generated by the simulation tool and appear on a user's screen of the simulation tool because of a mismatch between the energy quantity produced by biogas production and all the heat needs of the district.

Thereby, it is possible to add to the scenario which represents the system, a natural gas feed from the national network to feed the heating network and a new simulation is initiated.

A heating network feed rule is set within the simulation tool: all the energy produced by the biogas plant is recovered as heat (priority 1). The natural gas fulfils the unmet demand (priority 2).

The simulation result indicates a sustainable energy rate in the network which is lower than the threshold set, because of the presence of natural gas.

It is thereby possible to add to the scenario, an import of biowaste from cities close to the system.

The heating network feeding rule is unchanged.

The simulation result indicates that the sustainable energy rate determined is higher than the 60% objective.

An implementation of the method according to the invention is now described for modelling a district of 15 ha.

This modelling includes implementing in a simulation tool, such as a computer program product implementing the method according to the invention, a scenario representing a system including placing green roofs on all the district buildings.

An objective of rainwater quantity from the district in case of heavy rain is allocated to the simulation tool.

Data from a diagnostic module of the simulation tool, in particular the rainwater quantity fallen on the district during heavy rains, are imported into the simulation tool and a simulation is initiated.

The simulation result indicates that the rain volume from the district is higher than a set threshold.

It is thereby possible to add to the scenario a rainwater storage pool hydraulically connected to some district buildings only.

Several simulations can be initiated to test different dimensions of the storage pool until dimensions fulfiling the objective allocated to the simulation tool is found.

Of course, the invention is not limited to the examples just described and numerous modifications could be provided to these examples without departing from the scope of the invention. Moreover, the different characteristics, forms, alternatives and embodiments of the invention can be associated with each other according to various combinations insofar as they are not incompatible or exclusive to each other.

1. A method (100) for modelling a physical flow management system for a territory, the steps of which are implemented by a computer program product, the system comprising technical devices (202, 204, 206, 210) and points of use (208), of an urban service,
each technical device receiving on an input a physical flow called an input flow and applying a transformation to the input flow to deliver on an output a physical flow called an output flow,
each point of use receiving a physical flow called a need flow on an input and delivering a physical flow called a refuse flow on an output,
the technical devices and points of uses being connected to each other by means of junctions (2024, 2046, 2068, 2108),
said method comprising, from a predetermined list of physical flows forming a flow vector, the following steps:
a first step of forming (10) an oriented graph comprising nodes and oriented edges,
each technical device being represented by a node (302, 304, 306, 310) of the oriented graph, each of said nodes being associated with:
a first flow vector (v2e, v4e, v6e, v10e), called an input flow vector, representative of the input flow of said node,
a second flow vector (v2s, v4s, v6s, v10s), called an output flow vector, representative of the output flow of said node,
a mathematical function (f2, f4, f6, f10), called a transformation function, representing a relationship between the output flow vector and the input flow vector,
each point of use being represented by a node (308) of the oriented graph, each of said nodes being associated with:
a first flow vector (v8e), called a need flow vector representing the physical flow quantities necessary to said territory,
a second flow vector (v8s), called a refuse flow vector representing the physical flow quantities generated by said territory,
each junction between the output of a technical device and the input of another technical device being represented by an oriented edge (3042, 3064, 3086, 3108) of the oriented graph, the oriented edge connecting on the one hand the node associated with the technical device or with the point of use; and on the other hand the node associated with the other technical device or to the point of use,
iteratively, for each oriented edge connected to a node either the input flow vector, or the output flow vector of which is determined beforehand, a second step of determining (122) the other vector by using the transformation function.

2. The method according to claim 1, wherein a technical device is associated with intrinsic characteristics and/or with extrinsic characteristics to the device in the system.

3. The method according to claim 1, comprising a third step of checking the assignment of each flow to an adapted technical device.

4. The method according to claim 1, including checking matching the physical flow management system of the territory to the urban service.

5. The method according to claim 1, including, for each technical device:
a fourth step of determining a test value from components of the input flow vector and/or of the output flow vector,
a fifth step of comparing the test value to a range of permissible values for said technical device.

6. The method according to claim 1, comprising a sixth step of aggregating nodes to form an aggregate of a sub-set of nodes comprising a flow vector called an input flow vector and a flow vector called an output flow vector, wherein:
the input flow vector is determined by adding the output vectors of the outer nodes to the sub-set and connected by an edge toward an inner node to the sub-set,
the output flow vector is determined by adding the input vectors of the outer nodes to the sub-set and connected by an edge from an inner node to the sub-set.

7. The method according to claim 1, wherein the list of physical flows comprises two different categories of flow.

8. The method according to claim 1, wherein the list of physical flows comprises two different elementary flows.

9. The method according to claim 1, including, for each technical device, a step of determining environmental, economic and social impacts from components of the input flow vector and/or the output flow vector.

10. The method according to claim 1, wherein each node is associated with a player managing the device associated with the node.

11. The method according to claim 1, wherein each node is associated with a geographical position.

12. A non-transitory computer readable medium on which is stored software code portions, which when executed by a computer, cause the computer to execute the steps of the method according to claim 1.

13. The method according to claim 2, comprising a third step of checking the assignment of each flow to an adapted technical device.

14. The method according to claim 2, including checking matching the physical flow management system of the territory to the urban service.

15. The method according to claim 3, including checking matching the physical flow management system of the territory to the urban service.

16. The method according to claim 2, including, for each technical device:
a fourth step of determining a test value from components of the input flow vector and/or of the output flow vector,
a fifth step of comparing the test value to a range of permissible values for said technical device.

17. The method according to claim 3, including, for each technical device:
a fourth step of determining a test value from components of the input flow vector and/or of the output flow vector,
a fifth step of comparing the test value to a range of permissible values for said technical device.

18. The method according to claim 4, including, for each technical device:
a fourth step of determining a test value from components of the input flow vector and/or of the output flow vector,
a fifth step of comparing the test value to a range of permissible values for said technical device.

19. The method according to claim 2, comprising a sixth step of aggregating nodes to form an aggregate of a sub-set of nodes comprising a flow vector called an input flow vector and a flow vector called an output flow vector, wherein:
the input flow vector is determined by adding the output vectors of the outer nodes to the sub-set and connected by an edge toward an inner node to the sub-set,
the output flow vector is determined by adding the input vectors of the outer nodes to the sub-set and connected by an edge from an inner node to the sub-set.

20. The method according to claim 3, comprising a sixth step of aggregating nodes to form an aggregate of a sub-set of nodes comprising a flow vector called an input flow vector and a flow vector called an output flow vector, wherein:
the input flow vector is determined by adding the output vectors of the outer nodes to the sub-set and connected by an edge toward an inner node to the sub-set,
the output flow vector is determined by adding the input vectors of the outer nodes to the sub-set and connected by an edge from an inner node to the sub-set.
